(19) United States
(12) Patent Application Publication
(10) Pub. No.: US 2013/0162503 A1
(43) Pub. Date: Jun. 27, 2013

(54) DUAL DISPLAY STRUCTURE

(71) Applicants: Yi-Chang Chen, Taipei City (TW); Ke-Ming Chen, Taipei City (TW)

(72) Inventors: Yi-Chang Chen, Taipei City (TW); Ke-Ming Chen, Taipei City (TW)

(21) Appl. No.: 13/707,573

(22) Filed: Dec. 6, 2012

Related U.S. Application Data
(60) Provisional application No. 61/579,666, filed on Dec. 23, 2011.

(30) Foreign Application Priority Data
Nov. 12, 2012 (TW) 101142081

(51) Int. Cl. G09G 5/10

(52) U.S. Cl. CPC G09G 5/10
USPC 345/1.3

(57) ABSTRACT

A dual display structure including a light source, a light guide plate, a first display module and a second display module is provided. The light guide plate includes a light incident surface, a first light exiting surface and a second light exiting surface. The first and second display modules are respectively disposed at one side of the first and second exiting surfaces in parallel and back to each other. Light emitted from the light source enters the light guide plate through the light incident surface and emits to the first display module and the second display module through the first light exiting surface and the second light exiting surface.

### CROSS-REFERENCE TO RELATED APPLICATION

This application claims the priority benefit of U.S. Provisional Application Ser. No. 61/579,666, filed on Dec. 23, 2011. This application also claims the priority benefit of a Taiwan application serial no. 101142081, filed on Nov. 12, 2012. The entirety of each of the above-mentioned patent applications is hereby incorporated by reference herein and made a part of this specification.

### TECHNICAL FIELD

The disclosure relates to a display structure. Particularly, the disclosure relates to a dual display structure.

### BACKGROUND

In today's information society, portable electronic devices such as tablet personal computers (tablet PCs) and notebook computers have become indispensable necessity in people's daily life. Since the tablet PC include advantages of light weight and small size, it is easy to be carried by a user. Moreover, the user can hold the tablet PC with a single hand, which includes less field restriction in usage. The notebook computer includes better computing capability compared with that of the tablet PC, and includes a physical keyboard to facilitate the user to input data.

As improved development of electronic technology, the portable electronic devices are also quickly developed. A part of the portable electronic devices includes a dual display structure for providing more functions. Taking the notebook computer as an example, if two display modules are directly combined to form a dual display, a plurality of user can simultaneously view ore even perform operations on images displayed on the dual display from different positions. However, since direct combination of the two display modules leads to a large overall thickness, it is not only unsightly, when the displays are rotated relative to a host, a problem that the display modules cannot be maintained to required positions due to overweight is probably occurred, which may cause inconvenience in utilization.

### SUMMARY

The disclosure provides a dual display structure including a light source, a light guide plate, a first display module and a second display module. The light guide plate includes a light incident surface, a first light exiting surface and a second light exiting surface. The first display module is disposed at a side of the first light exiting surface. The second display module is disposed at a side of the second light exiting surface, and the first display module and the second display module are disposed in parallel and back to each other. A light emitted from the light source enters the light guide plate through the light incident surface, and emits to the first display module and the second display module through the first light exiting surface and the second light exiting surface.

The disclosure further provides a dual display structure including a reflector, a first backlight module, a first display module, a second backlight module and a second display module. The reflector includes a first surface and a second surface. The first backlight module is disposed on the first surface of the reflector, and the first backlight module includes a first light source and a first light guide plate. The first display module is disposed at a side of the first backlight module. The second backlight module is disposed on the second surface of the reflector, and the second backlight module includes a second light source and a second light guide plate. The second display module is disposed at a side of the second backlight module, and the first display module and the second display module are disposed in parallel and back to each other.

According to the above descriptions, in the dual display structure of the disclosure, the first display module and the second display module share the light guide plate or the reflector to decrease a thickness of the dual display structure.

Taking share of the light guide plate as an example, the light guide plate may include a shape of trapezoid, and after the light enters the light guide plate, it can emit to the first display module and the second display module from two side surfaces of the trapezoid to simultaneously provide a planar light source to the first display module and the second display module. Taking share of the reflector as an example, the reflector can be disposed between the first backlight module and the second backlight module, and the light that does not emit to the first display module and the second display module is reflected to the first light guide plate and the second light guide plate by the two surfaces of the reflector, and is guided to the first display module and the second display module. Moreover, in the dual display structure of the disclosure, a single frame is used to support the first display module and the second display module to decrease thickness of members of the dual display structure. Furthermore, the dual display structure of the disclosure senses a relative position of the first display module and the host through a switch module, and switches the image to at least one of the first display module and the second display module, so as to provide the user more usage manners.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a dual display structure according to a first embodiment of the disclosure.

FIG. 2A and FIG. 2B are schematic diagrams of the dual display structure of FIG. 1 pivoted to a host.

FIG. 3A is a schematic diagram of a dual display structure according to a second embodiment of the disclosure.

FIG. 3B is a schematic diagram of a dual display structure according to a third embodiment of the disclosure.

FIG. 4 is a schematic diagram of a dual display structure according to a fourth embodiment of the disclosure.

### DETAILED DESCRIPTION OF DISCLOSED EMBODIMENTS

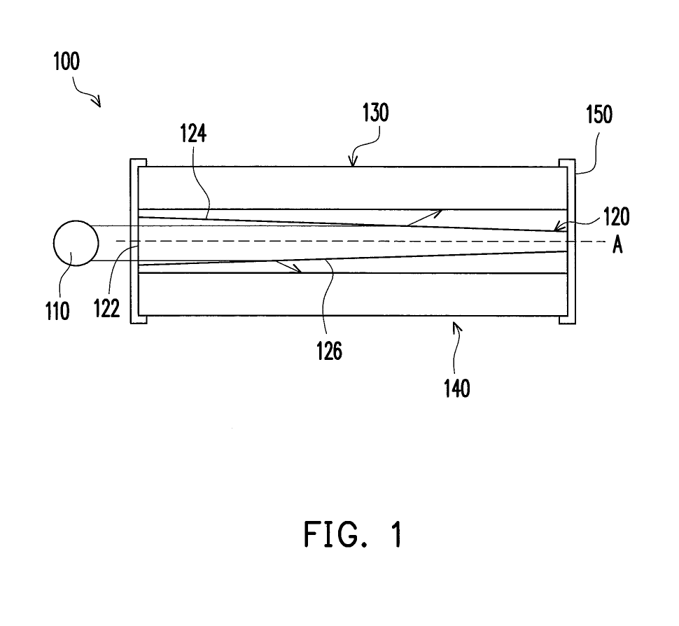

FIG. 1 is a schematic diagram of a dual display structure according to a first embodiment of the disclosure. Referring to FIG. 1, the dual display structure 100 of the present embodiment includes a light source 110, a light guide plate 120, a first display module 130 and a second display module 140.

In the present embodiment, the light source 110 is a light emitting diode (LED), though the type of the light source 110 is not limited thereto. The light guide plate 120 includes a light incident surface 122, a first light exiting surface 124 and a second light exiting surface 126. The first display module 130 and the second display module 140 are respectively disposed at one side of the first light exiting surface 124 and one side of the second light exiting surface 126 in parallel and back to each other.

A light emitted from the light source 110 enters the light guide plate 120 through the light incident surface 122, and respectively emits to the first display module 130 and the second display module 140 through the first light exiting surface 124 and the second light exiting surface 126.

In the present embodiment, the light guide plate 120 includes a shape of trapezoid, the incident surface 122 is a bottom surface of the trapezoid, and the first light exiting surface 124 and the second light exiting surface 126 are respectively two side surfaces of the trapezoid.

In the present embodiment, the first light exiting surface 124 and the second light exiting surface 126 are symmetric to a central axis A of the light incident surface 122, namely, a cross section of the light guide plate 120 includes a shape of isosceles trapezoid, though the shape of the light guide plate 120 is not limited thereto. In other embodiments, the first light exiting surface 124 and the second light exiting surface 126 can also be not symmetric to the central axis A of the light incident surface 122, which is not limited by the disclosure.

In the present embodiment, the dual display structure 100 further includes a frame 150, and the first display module 130 and the second display module 140 are fixed to the frame 150. The dual display structure 100 of the present embodiment fixes and supports the first display module 130 and the second display module 140 through the single frame 150, so as to decrease an overall thickness.

The dual display structure 100 of the present embodiment is pivoted and electrically connected to a host 10 to form a notebook computer. Certainly, a connection method between the dual display structure 100 and the host 10 is not limited thereto, and in other embodiments, the dual display structure can be directly fixed to the host or is not connected to the host as long as the dual display structure can be electrically connected to the host, which is not limited by the disclosure.

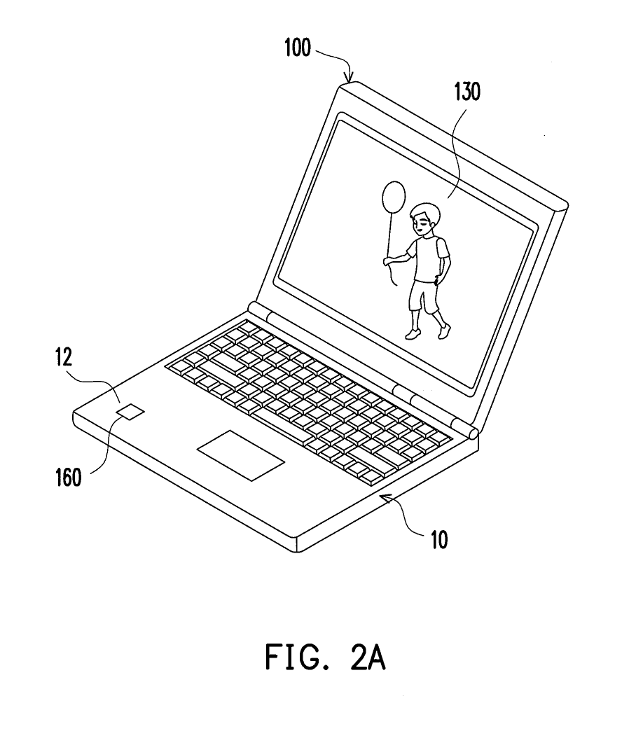

FIG. 2A and FIG. 2B are schematic diagrams of the dual display structure of FIG. 1 pivoted to a host. Referring to FIG. 2A and FIG. 2B, when the dual display structure 100 is pivoted to the host 10, the first display module 130 is, for example, an inner display of a general notebook computer, and the dual display structure 100 can be rotated relative to the host 10 to close/separate the first display module 130 to/from the host 10. When the dual display structure 100 is opened relative to the host 10 or is turned on, images can be displayed on the first display module 130, and the user can use such device as a general notebook computer (shown in FIG. 2A).

In the present embodiment, the dual display structure 100 further includes a switch module 160, and the switch module 160 is electrically connected to the first display module 130 and the second display module 140, and is disposed on a surface 12 of the host 10 opposite to the dual display structure 100 (for example, a place on the host 10 where the user's palm places). The switch module 160 can sense a relative position of the first display module 130 and the host 10 to switch the image to at least one of the first display module 130 and the second display module 140 for displaying. In other embodiments, the switch module 160 can also be disposed at a pivot joint of the dual display structure 100 and the host 10, though the position of the switch module 160 is not limited thereto.

In detail, when the switch module 160 senses that the first display module 130 is closed to the host 10, it probably represents that the user stops using such device and close the dual display structure 100 and the host 10 to make the device entering a hibernation state, or probably represents that the user wants to switch the image to the second display module 140. At this moment, the host 10 stops supplying power to the first display module 130 and displays the above two options on the second display module 140 for the user to select, and if the user selects to enter the hibernation state, the host 10 stops supplying power to the second display module 140. If the user selects to switch the image to the second display module 140, the host 10 continually supplies power to the second display module 140 to display the image (shown in FIG. 2B).

Moreover, directions of the images displayed by the first display module 130 and the second display module 140 can be the same or opposite. For example, when different users respectively stand in front of the first display module 130 and the second display module 140 to simultaneously view images, the first display module 130 and the second display module 140 can display images with the same direction (i.e. bottoms of the images displayed by the first display module 130 and the second display module 140 are both close to the pivot joint of the dual display structure 100 and the host 10), so that a plurality of users of the first display module 130 and the second display module 140 can simultaneously view the images or perform operations.

When the user closes the dual display structure 100 to the host 10 to use it as a tablet PC, to facilitate the user, the first display module 130 and the second display module 140 can also display image with opposite directions, namely, if the bottom of the image displayed by the first display module 130 is close to the pivot joint of the dual display structure 100 and the host 10, the bottom of the image displayed by the second display module 140 is away from the pivot joint of the dual display structure 100 and the host 10, so that the user does not need to turn the device to view the image displayed on the second display module 140.

In case that the dual display structure 100 is pivoted and electrically connected to the host 10, it can be used as a notebook computer to display the image on the first display module 130. When the first display module 130 is not used, the dual display structure 100 is rotated towards the host 10, and the first display module 130 contacts the host 10. At this moment, the image of the host 10 can be switched to the second display module 140.

In the present embodiment, the second display module 140 can be a touch panel, and the user can operate the second display module 140 by touching, and the device can be used as a tablet PC to achieve an multipurpose effect on one machine, which is not only convenient but also economic. Moreover, since data is stored in the host 10, multi-machine management of files is unnecessary, which is more user-effective.

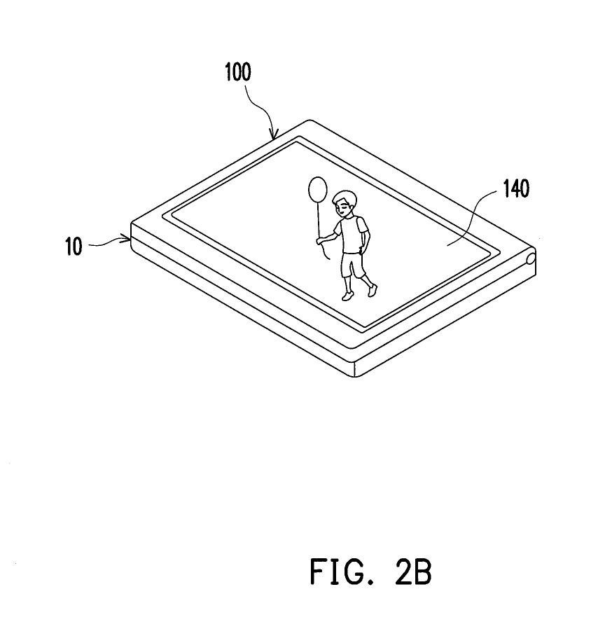

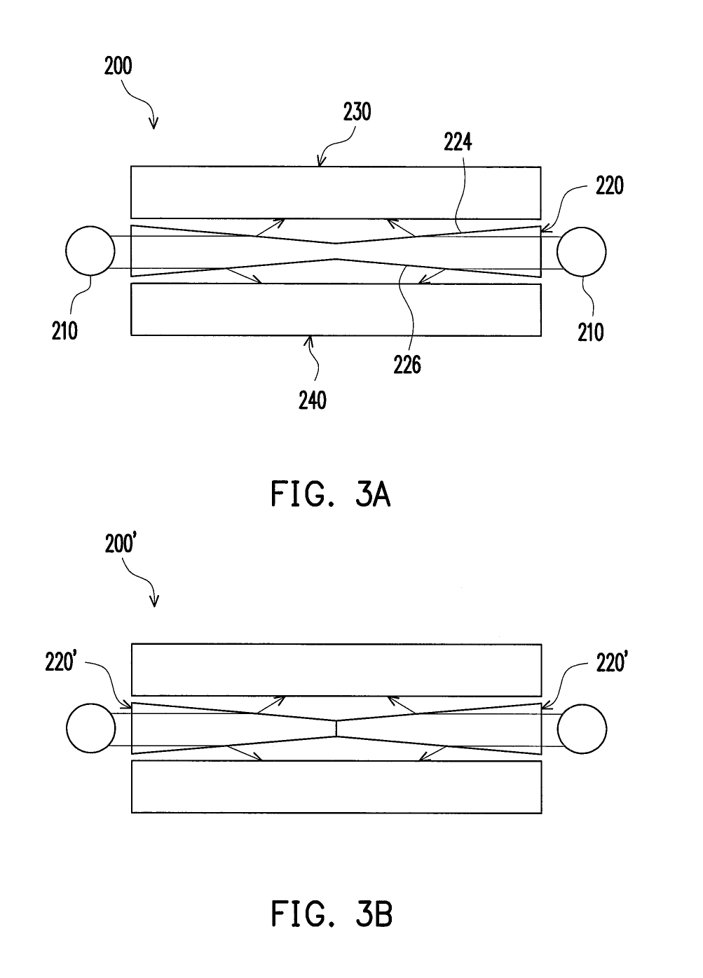

FIG. 3A is a schematic diagram of a dual display structure according to a second embodiment of the disclosure. Referring to FIG. 3A, a main difference between the dual display structure 200 of FIG. 3A and the dual display structure 100 of FIG. 1 is that the dual display structure 200 of FIG. 3A includes two light sources 210, and an light guide plate 220 thereof includes a hourglass shape (a cross section thereof is two trapezoids with two connected top surfaces, and the shapes of the two trapezoids are the same). As shown in FIG. 3A, the two light sources 210 are respectively disposed at the top surface and the bottom surface of the hourglass shape, and the lights are emitted from two opposite sides to provide uniform planar light sources to a first display module 230 and a second display module 240.

Certainly, the shape of the light guide plate 220 is not limited to that described above, which is applicable as long as the light can emitted to the first display module 230 and the second display module 240 through a first light exiting surface 224 and a second light exiting surface 226 to simultaneously provide the planar light sources to the first display module 230 and the second display module 240.

FIG. 3B is a schematic diagram of a dual display structure according to a third embodiment of the disclosure. Referring to FIG. 3B, a main difference between the dual display structure 200′ of FIG. 3B and the dual display structure 200 of FIG. 3A is that the dual display structure 200′ of FIG. 3B includes two light guide plates 220′, and each of the light guide plates 220′ includes a shape of trapezoid, and the two light guide plates 220′ are connected through top surfaces of the trapezoids. The dual display structure 200 of FIG. 3A only includes a single light guide plate 220. Certainly, the shape of the light guide plate 220 is not limited as that described above.

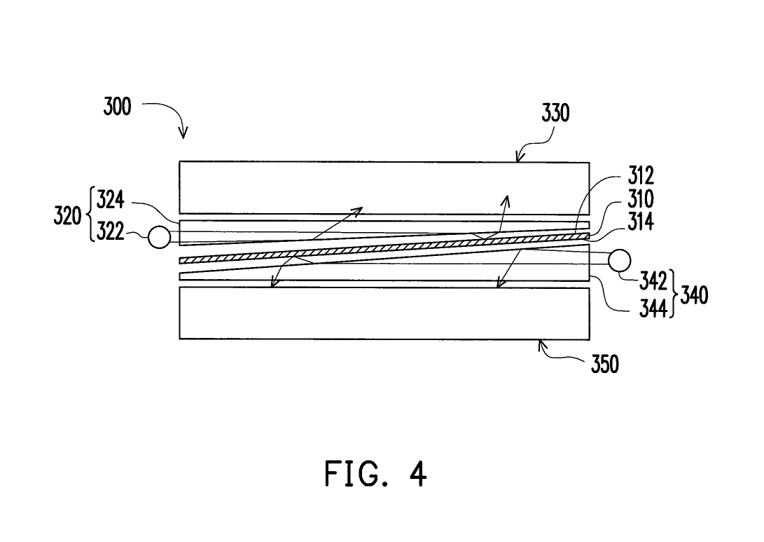

FIG. 4 is a schematic diagram of a dual display structure according to a fourth embodiment of the disclosure. Referring to FIG. 4, a main difference between the dual display structure 300 of FIG. 4 and the dual display structure 200 of FIG. 3 is that in the dual display structure 200 of FIG. 3, the light guide plate 220 is shared to decrease an overall thickness, and the dual display structure 200 of FIG. 3 is not configured with a reflector, though in the dual display structure 300 of FIG. 4, a reflector 310 is shared to decrease the overall thickness. The dual display structure 300 of FIG. 4 is described in detail below.

The dual display structure 300 of the present embodiment includes a reflector 310, a first backlight module 320, a first display module 330, a second backlight module 340 and a second display module 350. The reflector 310 includes a first surface 312 and a second surface 314 opposite to each other. The first backlight module 320 is disposed on the first surface 312 of the reflector 310, and the first backlight module 320 includes a first light source 322 and a first light guide plate 324. The first display module 330 is disposed at a side of the first backlight module 320. The second backlight module 340 is disposed on the second surface 314 of the reflector 310, and the second backlight module 340 includes a second light source 342 and a second light guide plate 344. The second display module 350 is disposed at a side of the second backlight module 340, and the first display module 330 and the second display module 350 are disposed in parallel and back to each other.

As shown in FIG. 4, lights emitted from the first light source 322 and the second light source 342 respectively enter the first light guide plate 324 and the second light guide plate 344, and a part of the light directly emits to the first display module 330 and the second display module 350 through the first light guide plate 324 and the second light guide plate 344, and the other part of the light emits towards other directions through the first light guide plate 324 and the second light guide plate 344.

Since the reflector 310 is located between the first backlight module 320 and the second backlight module 340, such part of the light is reflected back to the first light guide plate 324 and the second light guide plate 344 by the first surface 312 and the second surface 314 of the reflector 310, and is guided to the first display module 330 and the second display module 350.

In the dual display structure 300 of the present embodiment, as the first backlight module 320 supplying the planar light source to the first display module 330 and the second backlight module 340 supplying the planar light source to the second display module 350 share the same reflector 310, the thickness of the dual display structure is decreased.

In summary, in the dual display structure of the disclosure, the first display module and the second display module share the light guide plate or the reflector to decrease a thickness of the dual display structure. Taking share of the light guide plate as an example, the light guide plate may include a shape of trapezoid, and after the light enters the light guide plate, it can emit to the first display module and the second display module from two side surfaces of the trapezoid to simultaneously provide a planar light source to the first display module and the second display module.

Taking share of the reflector as an example, the reflector can be disposed between the first backlight module and the second backlight module, and the light that does not emit to the first display module and the second display module is reflected to the first light guide plate and the second light guide plate by two the surfaces of the reflector, and is guided to the first display module and the second display module. Moreover, the dual display structure of the disclosure uses a single frame to support the first display module and the second display module, so as to decrease the thickness of the members of the dual display structure.

Moreover, the dual display structure of the disclosure senses a relative position of the first display module and the host through a switch module, and switches the image to at least one of the first display module and the second display module, so as to provide the user more usage manners.

It will be apparent to those skilled in the art that various modifications and variations can be made to the structure of the disclosure without departing from the scope of the disclosure. In view of the foregoing, it is intended that the disclosure cover modifications and variations of this disclosure provided they fall within the scope of the following claims and their equivalents.

What is claimed is:

1. A dual display structure, comprising:
a light source;
a light guide plate, comprising a light incident surface, a first light exiting surface and a second light exiting surface;
a first display module, disposed at a side of the first light exiting surface; and
a second display module, disposed at a side of the second light exiting surface, wherein the first display module and the second display module are disposed in parallel and back to each other,
wherein a light emitted from the light source enters the light guide plate through the light incident surface, and emits to the first display module and the second display module through the first light exiting surface and the second light exiting surface.

2. The dual display structure as claimed in claim 1, wherein the light guide plate has a shape of a trapezoid, the light incident surface is a bottom surface of the trapezoid, and the first light exiting surface and the second light exiting surface are respectively two side surfaces of the trapezoid.

3. The dual display structure as claimed in claim 1, wherein the first light exiting surface and the second light exiting surface are symmetric to a central axis of the light incident surface.

4. The dual display structure as claimed in claim 1, further comprising:
a frame, wherein the first display module and the second display module are fixed to the frame.

5. The dual display structure as claimed in claim 1, further comprising:
a switch module, electrically connected to the first display module and the second display module, and the dual display structure being electrically connected a host.

6. The dual display structure as claimed in claim 5, wherein the switch module is disposed at a pivot joint of the dual display structure and the host or on a surface of the host opposite to the dual display structure.

7. A dual display structure, comprising:
a reflector, comprising a first surface and a second surface;
a first backlight module, disposed on the first surface of the reflector, and the first backlight module comprising a first light source and a first light guide plate;
a first display module, disposed at a side of the first backlight module;
a second backlight module, disposed on the second surface of the reflector, and the second backlight module comprising a second light source and a second light guide plate; and
a second display module, disposed at a side of the second backlight module, wherein the first display module and the second display module are disposed in parallel and back to each other.

8. The dual display structure as claimed in claim 7, further comprising:
a frame, wherein the first display module and the second display module are fixed to the frame.

9. The dual display structure as claimed in claim 7, further comprising:
a switch module, electrically connected to the first display module and the second display module, and the dual display structure being electrically connected a host.

10. The dual display structure as claimed in claim 9, wherein the switch module is disposed at a pivot joint of the dual display structure and the host or on a surface of the host opposite to the dual display structure.
